(19) United States
(12) Patent Application Publication
(10) Pub. No.: US 2025/0001763 A1
(43) Pub. Date: Jan. 2, 2025

(54) TANK HAVING FIRST AND SECOND SENSORS FOR DETECTING LIQUID LEVEL IN STORAGE CHAMBER, AND IMAGE RECORDING APPARATUS INCLUDING THE SAME

(71) Applicant: BROTHER KOGYO KABUSHIKI KAISHA, Nagoya (JP)

(72) Inventors: Masahiro HAYASHI, Anjo (JP); Naoya OKAZAKI, Hashima (JP); Satoru OKI, Nagoya (JP); Yuma TANABE, Nagoya (JP); Yuji FUKUTA, Nagoya (JP)

(73) Assignee: BROTHER KOGYO KABUSHIKI KAISHA, Nagoya (JP)

(21) Appl. No.: 18/748,535

(22) Filed: Jun. 20, 2024

(30) Foreign Application Priority Data
Jun. 30, 2023 (JP) 2023-108499

(51) Int. Cl. B41J 2/175; B41J 29/46

(52) U.S. Cl. CPC B41J 2/17566; B41J 29/46; B41J 2002/17573

(57) ABSTRACT

A tank includes: a liquid storage chamber configured to receive liquid from a liquid container connectable to the tank; a first sensor; and a second sensor. The liquid storage chamber defines therein a first detecting position and a second detecting position spaced apart from each other in a horizontal direction. The liquid storage chamber has: a liquid inlet port positioned above the first detecting position and the second detecting position; and a liquid outlet port positioned below the first detecting position and the second detecting position. The first sensor outputs a first signal when detecting the liquid at the first detecting position and outputs a second signal when not detecting the liquid at the first detecting position. The second sensor outputs a third signal when detecting the liquid at the second detecting position and outputs a fourth signal when not detecting the liquid at the second detecting position.

### REFERENCE TO RELATED APPLICATIONS

This application claims priority from Japanese Patent Application No. 2023-108499 filed on Jun. 30, 2023. The entire content of the priority application is incorporated herein by reference.

### BACKGROUND ART

There has been known a tank connectable to a liquid cartridge. The tank has a rear wall provided with a sensor configured to detect whether a level of ink stored in the tank becomes a first position. The first position is adjacent to an outlet opening positioned in a bottom wall of the tank. When the level of ink is detected to be lowered to the first position, a user is configured to be informed about the detection by the sensor. Hence, the user can recognize that the residual amount of ink in the tank or in the liquid cartridge is reduced.

### SUMMARY

In the above-described tank, the bottom surface of the tank is inclined with respect to a horizontal plane if a conventional printer including the above-described tank is placed on a surface that is inclined relative to the horizontal plane. At this time, even if a sufficient amount of ink is still stored in the tank (to exhibit the ink level higher than the first position if the bottom surface of the tank extends horizontally), the sensor may not be able to detect the ink in the tank since the liquid surface of the ink is also inclined relative to the bottom surface of the tank. As such, accuracy in detection of the residual amount of ink by the sensor is likely to be degraded in a case where the bottom surface of the tank is inclined with respect to the horizontal plane.

In view of the foregoing, it is an object of the present disclosure to provide a tank and an image-recording apparatus capable of restraining degradation in sensor's detection accuracy of the residual amount of liquid in the tank when the bottom surface of the tank is inclined with respect to the horizontal plane.

In order to attain the above and other object, according to one aspect, the present disclosure provides a tank to which a liquid container storing liquid therein is connectable. The tank includes a liquid storage chamber, a first sensor, and a second sensor. The liquid storage chamber is configured to store the liquid supplied from the liquid container connected to the tank. The liquid storage chamber defines a first detecting position and a second detecting position therein. The first detecting position and the second detecting position are spaced apart from each other in a horizontal direction. The liquid storage chamber has a liquid inlet port and a liquid outlet port. The liquid in the liquid container is to be supplied through the liquid inlet port. The liquid inlet port is positioned above the first detecting position and the second detecting position in an up-down direction. The liquid in the liquid storage chamber is to be discharged through the liquid outlet port. The liquid outlet port is positioned lower than the first detecting position and the second detecting position in the up-down direction. The first sensor is configured to detect the liquid at the first detecting position. The first sensor is configured to output a first signal in response to detecting the liquid at the first detecting position and output a second signal in response to not detecting the liquid at the first detecting position. The second sensor is configured to detect the liquid at the second detecting position. The second sensor is configured to output a third signal in response to detecting the liquid at the second detecting position and output a fourth signal in response to not detecting the liquid at the second detecting position.

Here, assume that the liquid storage chamber of the tank stores such an amount of liquid that the level of the liquid is higher than the first detecting position in a state where an image recording apparatus including the tank is set on a horizontal plane. In a case where the image recording device is set on a surface that is inclined relative to the horizontal plane, the bottom surface of the tank is also inclined with respect to the horizontal plane. Hence, the liquid surface of the liquid stored in the liquid storage chamber is inclined relative to the bottom surface of the liquid storage chamber.

At this time, the liquid surface of the liquid is likely to be higher than one of the first detecting position and the second detecting position (although the liquid surface would be lower than a remaining one of the first detecting position and the second detecting position), since the first detecting position and the second detecting position are spaced apart from each other in the horizontal direction. In this state, either the first signal indicating that the liquid is detected at the first detecting position or the third signal indicating that the liquid is detected at the second detecting position is likely to be outputted.

That is, this configuration can reliably restrain occurrence of such a detection failure that little liquid is detected to be left in the liquid storage chamber even if the liquid storage chamber stores a sufficient amount of liquid to provide the level of the liquid that is higher than the first detecting position in the state where the image recording apparatus was set on the horizontal plane. Hence, accuracy in detection of the residual amount of the liquid by the sensors can be restrained from getting degraded.

According to another aspect, the disclosure also provides an image recording apparatus including the above-described tank. Specifically, the image recording apparatus includes the tank according to the one aspect, an ejection head, an alarm unit, and a controller. The ejection head is configured to eject the liquid supplied from the tank through the liquid outlet port. The alarm unit is configured to perform a low-level notification to notify that an amount of the liquid stored in the liquid storage chamber is small. The controller is electrically connected to the first sensor, the second sensor and the alarm unit. The controller is configured to control the alarm unit to perform the low-level notification in response to receiving both the second signal and the fourth signal.

Assume that the liquid storage chamber of the tank stores such an amount of liquid that the level of the liquid is higher than the first detecting position in a state where the above image recording apparatus is set on a horizontal plane. In a case where the image recording apparatus is set on a surface that is inclined relative to the horizontal plane, the bottom surface of the tank is also inclined with respect to the horizontal plane. Hence, the liquid surface of the liquid stored in the liquid storage chamber is inclined relative to the bottom surface of the liquid storage chamber.

At this time, the liquid surface of the liquid is likely to be higher than one of the first detecting position and the second detecting position, although the liquid surface would be lower than a remaining one of the first detecting position and the second detecting position, since the first detecting position and the second detecting position are spaced apart from each other in the horizontal direction. If the liquid supplied from the tank through the liquid outlet port is ejected from the ejection head in this state, the liquid level in the liquid storage chamber declines in accordance with the ejection of the liquid. Once the liquid surface of the liquid stored in the liquid storage chamber goes down below one of the first detecting position and the second detecting position, the controller controls the alarm unit to perform the low-level notification indicating that the amount of the liquid left in the liquid storage chamber is small. Accordingly, this configuration can reliably restrain the alarm unit from performing the low-level notification when the liquid surface of the liquid in the liquid storage chamber is inclined relative to the bottom surface of the liquid storage chamber, in a case where the liquid storage chamber stores a sufficient amount of liquid to provide the level of the liquid that is higher than the first detecting position if the image recording apparatus was set on a horizontal plane. Hence, detection accuracy on detection of the residual amount of the liquid by the sensors is less likely to be degraded.

### BRIEF DESCRIPTION OF DRAWINGS

FIG. 1A is a perspective view of a multifunction device 10 according to one embodiment of the disclosure in a state where a scanner unit 12 is at a closed position.

FIG. 1B is a perspective view of the multifunction device 10 according to the one embodiment in a state where the scanner unit 12 is at an open position.

FIG. 2 is a schematic vertical cross-sectional view illustrating an internal structure of a printer unit 11 in the multifunction device 10.

FIG. 3 is a schematic view illustrating a recording portion 21, a black tank 18, and a structure in the vicinity of the black tank 18 in the multifunction device 10.

FIG. 4 is a block diagram of a controller 130 in the multifunction device 10.

FIG. 5 is a flowchart illustrating a processing performed by the controller 130 for detecting a residual amount of ink.

FIG. 6 is a schematic view illustrating a state where the black tank 18 whose outlet opening 111B is positioned near a front end of a lower wall 154 is inclined relative to a front-rear direction 8 such that a rear end of the lower wall 154 is positioned below the front end.

FIG. 7 is a schematic view illustrating a black tank 18A according to a modification to the embodiment where the outlet opening 111B is positioned near a rear end of a lower wall 154A and the black tank 18A is inclined relative to the front-rear direction 8 such that a front end of the lower wall 154A is positioned below the rear end.

FIG. 8 is a flowchart illustrating a processing performed by the controller 130 for detecting a residual amount of ink stored in the black tank 18A illustrated in FIG. 7.

FIG. 9 is a schematic view illustrating a black tank 18B according to another modification to the embodiment where the outlet opening 111B is positioned at a general center of a lower wall 154B and the black tank 18B is inclined relative to the front-rear direction 8 such that a rear end of the lower wall 154B is positioned below a front end thereof.

FIG. 10 is a flowchart illustrating a processing performed by the controller 130 for detecting a residual amount of ink stored in the black tank 18B illustrated in FIG. 9.

### DESCRIPTION

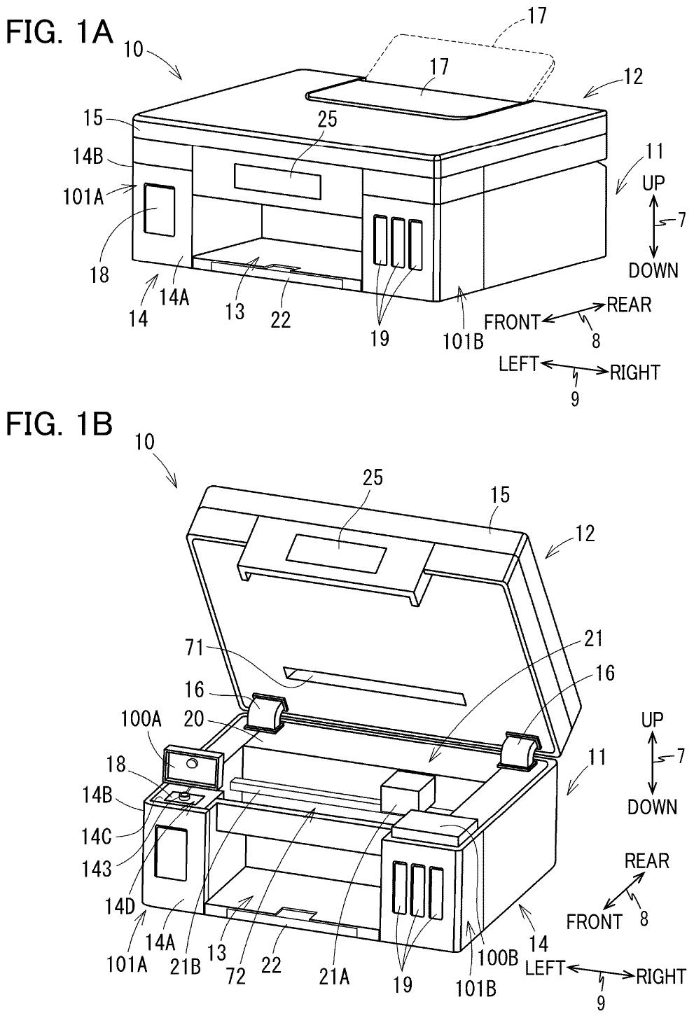

A multifunction device 10 according to one embodiment of the present disclosure will be described with reference to FIGS. 1 through 6.

In the following description, directions in relation to the multifunction device 10 will be referred to assuming that the multifunction device 10 is resting on a horizontal surface such that a black tank 18 and a multi-color tank 19 of the multifunction device 10 can be used (i.e., “operable posture” illustrated in FIG. 1).

Specifically, upper and lower sides with respect to the multifunction device 10 (i.e., up-down direction 7) will be defined based on the operable posture of the multifunction device 10. Further, front and rear sides with respect to the multifunction device 10 (i.e., front-rear direction 8) will be defined such that a surface of a main housing 14 (FIG. 1) formed with an opening 13 (FIG. 1) is regarded as a front surface of the multifunction device 10. Further, left and right sides with respect to the multifunction device 10 (i.e., left-right direction 9) will be defined based on a perspective of a user facing the front surface of the multifunction device 10. In the present embodiment, the up-down direction 7, the front-rear direction 8, and the left-right direction 9 are perpendicular to one another.

### Overview of the Multifunction Device 10

As illustrated in FIG. 1A, the multifunction device 10 (an example of an image-recoding apparatus of the disclosure) has a substantially rectangular parallelepiped shape. The multifunction device 10 includes a printer unit 11 and a scanner unit 12. The multifunction device 10 may also have a facsimile function.

The multifunction device 10 includes the main housing 14 and a movable housing 15.

### <Scanner Unit 12 and Movable Housing 15>

As illustrated in FIG. 1A, the scanner unit 12 constitutes an upper portion of the multifunction device 10. The scanner unit 12 is provided in the movable housing 15. The movable housing 15 has a substantially rectangular parallelepiped shape. The movable housing 15 is connected to an upper-rear end portion of the main housing 14 through a pair of connecters 16 (see FIG. 1B). Through the connectors 16, the movable housing 15 is pivotally movable relative to the main housing 14.

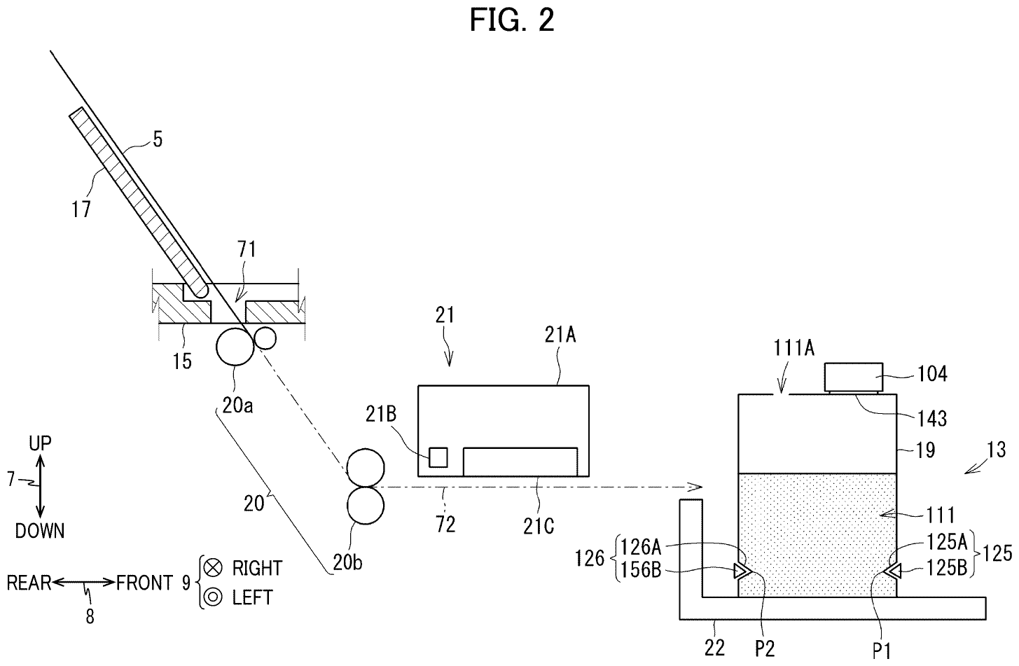

As illustrated in FIG. 1B, the movable housing 15 is opened relative to the main housing 14 when a user lifts up a front end portion of the movable housing 15. In a state where the movable housing 15 is opened, a recording portion 21 (see FIG. 2) positioned inside the main housing 14, and covers 100A, 100B and the like are exposed to an outside through an open space between the main housing 14 and the movable housing 15, i.e., through the space above the main housing 14. In this state, the user can manipulate the covers 100A and 100B. As illustrated in FIG. 1A, in a state where the movable housing 15 is closed, the recording portion 21 and the covers 100A, 100B are not exposed to the outside.

### <Printer Unit 11 and Main Housing 14>

The printer unit 11 constitutes a lower portion of the multifunction device 10. The printer unit 11 is configured to record an image on a sheet-like image recording medium 5 (FIG. 2) through a so-called ink jet recording system. The image recording medium 5 may be a sheet of paper, cloth, a plastic sheet, an OHP sheet, and an envelope, for example. The printer unit 11 includes a sheet supply tray 17, and an inlet 71 provided in the movable housing 15. The inlet 71 allows the image recording medium 5 to be inserted therethrough and to be conveyed to the printer unit 11 for image recordation. The sheet supply tray 17 is configured to open and close the inlet 71 at an upper surface of the movable housing 15.

Specifically, the sheet supply tray 17 is pivotally movable between a first state (indicated by a solid line in FIG. 1A) where the sheet supply tray 17 covers a part of the upper surface of the movable housing 15 to close the inlet 71 and a second state (indicated by a broken line in FIG. 1A) where the sheet supply tray 17 protrudes rearward from the movable housing 15 to open the inlet 71. Further, in the second state, an upper surface of the sheet supply tray 17 functions as a tray surface configured to support the image recording medium 5 and guide the image recording medium 5 toward the inlet 71.

The printer unit 11 includes the main housing 14. The main housing 14 has a box-like shape that is open upward. The main housing 14 has a front wall 14A formed with the opening 13. Further, as illustrated in FIG. 2, the printer unit 11 also includes a conveyor 20, a conveying passage 72, the recording portion 21, and a discharge tray 22 all of which are positioned in an internal space of the main housing 14.

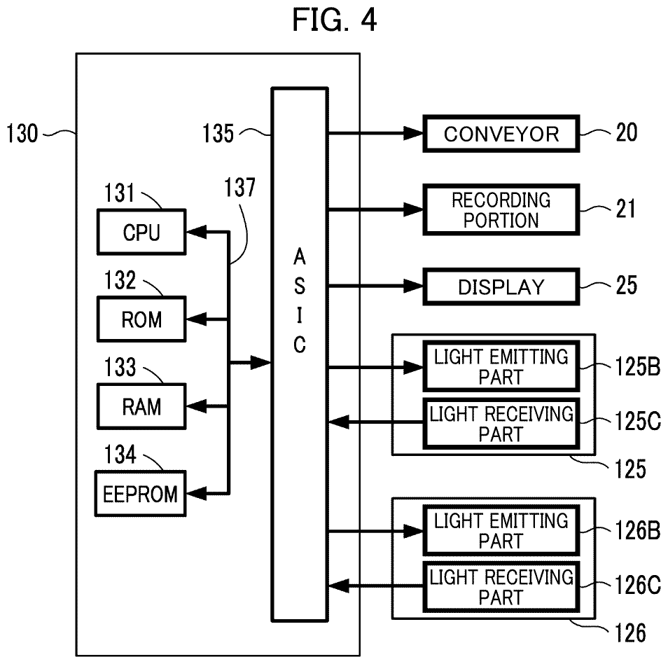

The conveyor 20 is configured to convey the image recording medium 5 on the sheet supply tray 17 to the conveying passage 72 through the inlet 71 in a conveying direction. In other words, the conveyor 20 is configured to convey the image recording medium 5 along the conveying passage 72 to a position below a head 21A of the recording portion 21. In the present embodiment, the conveyor 20 includes an upstream-side conveyor 20a and a downstream-side conveyor 20b. The upstream-side conveyor 20a is positioned adjacent to the inlet 71 and downstream of the inlet 71 in the conveying direction. The downstream-side conveyor 20b is positioned adjacent to the recording portion 21 and upstream of the recording portion 21 in the conveying direction. The conveyor 20 is electrically connected to a controller 130 (FIG. 4) such that the controller 130 can control driving of the conveyor 20.

The conveying passage 72 is a path along which the image recording medium 5 that has moved past the inlet 71 is configured to be conveyed. The conveying passage 72 extends from the upstream-side conveyor 20a to reach the recording portion 21 while passing through the downstream-side conveyor 20b.

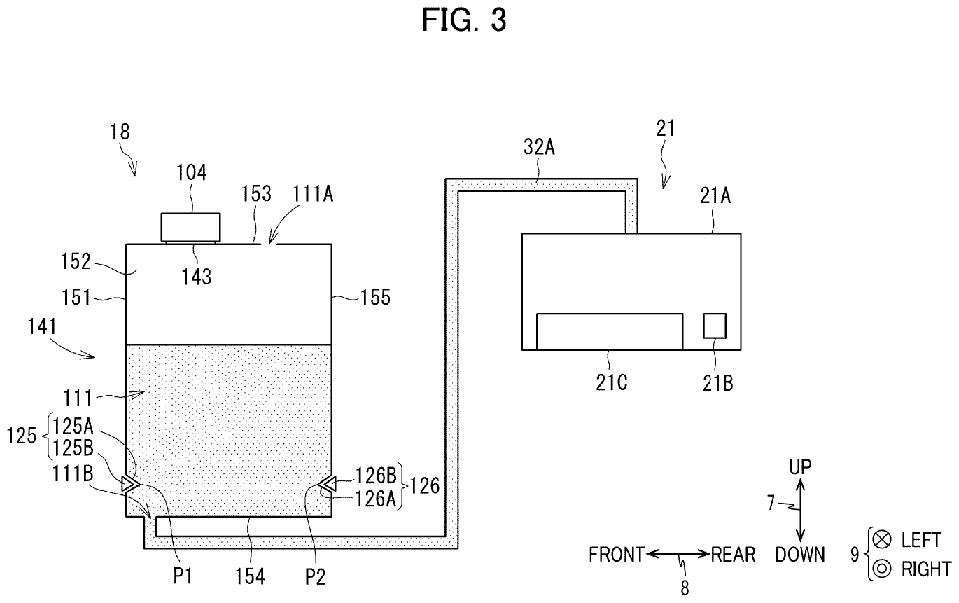

The recording portion 21 includes the head 21A and a guide rail 21B configured to guide the head 21A in the left-right direction 9. To the head 21A, ink stored in the black tank 18 and multi-color tank 19 is configured to be supplied through an ink tube 32A (see FIG. 3). The head 21A has a lower surface 21C where a plurality of nozzles is formed for ejecting ink toward the image recording medium 5 positioned below the head 21A. In this way, an image is recorded on the image recording medium 5. That is, the recording portion 21 is configured to consume the ink. The recording portion 21 is electrically connected to the controller 130. The controller 130 is configured to control ejection of the ink in the head 21A. The head 21A is an example of an “ejection head” of the disclosure.

As illustrated in FIGS. 1A and 1B, the discharge tray 22 is positioned below and frontward of the recording portion 21 inside the opening 13. The discharge tray 22 is configured to support the image recording medium 5 on which an image is recorded by the recording portion 21.

### <Black Tank 18 and Multi-Color Tank 19>

The multifunction device 10 further includes the black tank 18 and the multi-color tank 19 provided inside the main housing 14, as illustrated in FIGS. 1A and 1B. The black tank 18 and the multi-color tank 19 are stationarily installed inside the main housing 14. Here, “stationarily installed” means that the black tank 18 and the multi-color tank 19 are assumed not to be exchanged with new ones by the user, but these tanks 18 and 19 are fixed to the main housing 14 and are configured to be replenished with fresh ink.

The black tank 18 is stationarily installed in a tank receiving portion 101A in its operable posture. The black tank 18 is configured to store black ink therein (as an example of “liquid” of the disclosure). The tank receiving portion 101A is provided on the left side of the opening 13 in a front end portion within the internal space of the main housing 14. The tank receiving portion 101A has an internal space that is defined by a bottom wall (not illustrated), the front wall 14A, a left wall 14B, a top wall 14C, and other walls of the main housing 14. The top wall 14C is positioned on upper ends of the front wall 14A, the left wall 14B, and the other walls such that the top wall 14C closes the internal space of the tank receiving portion 101A from above. The top wall 14C has a center portion formed with an opening 14D. Through the opening 14D, an inlet port 143 of the black tank 18 (see FIG. 3) is exposed to the outside.

The black tank 18 has a generally rectangular parallelepiped shape. As illustrated in FIG. 3, the black tank 18 includes a casing 141, a first sensor 125, and a second sensor 126. The black tank 18 is an example of “tank” of the disclosure.

### <Casing 141>

The casing 141 is made of resin such as polypropylene. The resin forming the casing 141 has a translucency capable of transmitting light to such a degree that a user can recognize how much ink is stored in the black tank 18 through a window formed in the front wall 14A of the main housing 14 (see FIGS. 1A and 1B). The casing 141 is an integrally molded resin product manufactured by injection molding. Incidentally, the casing 141 may not be an integrally molded product, but may be configured by assembling a plurality of parts together.

Referring to FIG. 3, the casing 141 includes a front wall 151, a right wall 152, a left wall (not illustrated), an upper wall 153, a lower wall 154, and a rear wall 155. In the present embodiment, the non-illustrated left wall of the casing 141 closes the internal space of the casing 141. However, the casing 141 may have a left open end due to constrain of some kind at the time of molding. In a case where the left end of the casing 141 is opened, the left open end of the casing 141 may be closed by fixing a film (not illustrated) thereto by melt-bonding.

### <Ink Storage Chamber 111>

The closed internal space of the casing 141 serves as an ink storage chamber 111 of the casing 141. That is, the ink storage chamber 111 is defined by the front wall 151, the right wall 152, the left wall, the upper wall 153, the lower wall 154, and the rear wall 155. The ink storage chamber 111 has a rectangular parallelepiped shape that is elongated in the front-rear direction 8. That is, the ink storage chamber 111 has a dimension in the front-rear direction 8 that is greater than a dimension thereof in the left-right direction 9. The ink storage chamber 111 is configured to store black ink therein. The ink storage chamber 111 is open to the outside through the inlet port 143, an air communication port 111A, and an outlet port 111B.

The inlet port 143 is provided on the upper wall 153 at a position offset frontward from a front-rear center of the upper wall 153. The inlet port 143 protrudes upward from an upper surface of the upper wall 153. The inlet port 143 has an upper end that is open upward. The inlet port 143 allows communication between the ink storage chamber 111 and the outside of the black tank 18. The user can inject black ink into the ink storage chamber 111 through the inlet port 143. The inlet port 143 is an example of “liquid inlet port” of the disclosure. A cap 104 is attachable to and detachable from the inlet port 143 for closing and opening the inlet port 143.

The air communication port 111A is provided in the upper wall 153 at a position rearward of the inlet port 143. A semipermeable membrane may be adhesively attached to the upper wall 153 for closing the air communication port 111A. The semipermeable membrane is a microporous membrane capable of preventing ink to pass therethrough but allowing air to pass therethrough.

The outlet port 111B is positioned in a front end portion of the lower wall 154. One end of the ink tube 32A is connected to the outlet port 111B, while another end of the ink tube 32A is connected to the head 21A. The ink tube 32A is made of resin such that the ink tube 32A is elastically deformable. The ink stored in the ink storage chamber 111 flows into the ink tube 32A through the outlet port 111B, and is supplied to the head 21A through the ink tube 32A. The ink storage chamber 111 is an example of “liquid storage chamber” of the disclosure.

### <First Sensor 125>

The first sensor 125 is configured to detect whether the level of ink stored in the ink storage chamber 111 reaches a first detecting position P1. The first sensor 125 includes a prism 125A, a light emitting part 125B, and a light receiving part 125C (FIG. 4).

The prism 125A is provided on the front wall 151 at a position lower than a center of the front wall 151 in the up-down direction 7. In the present embodiment, the prism 125A constitutes a part of the front wall 151. The prism 125A is made of glass that can provide a reflection coefficient that vary depending on whether ink is in contact with the prism 125A or not. Thus, the first detecting position P1 is set at a position coincident with the position of the prism 125A in the up-down direction 7.

The light emitting part 125B and the light receiving part 125C are provided frontward of the prism 125A so as to face the prism 125A. The light emitting part 125B and the light receiving part 125C are supported by a front surface of the front wall 151. Incidentally, the light emitting part 125B and the light receiving part 125C may be supported by a rear surface of the front wall 14A defining the internal space of the tank receiving portion 101A. The light emitting part 125B is configured to emit light toward the prism 125A. The light emitting part 125B is electrically connected to the controller 130. The controller 130 is configured to control emission of the light from the light emitting part 125B.

The light receiving part 125C is configured to receive the light emitted from the light emitting part 125B and reflected by the prism 125A. The light receiving part 125C is electrically connected to the controller 130. The light receiving part 125C is configured to output signals indicative of intensity of the reflected light received at the light receiving part 125C.

Specifically, in a case where the level of the ink stored in the ink storage chamber 111 is higher than the first detecting position P1, the ink is in contact with the prism 125A on an optical path of the light emitted from the light emitting part 125B toward the prism 125A. At this time, the light emitted from the light emitting part 125B toward the prism 125A transmits through the prism 125A and enters the ink storage chamber 111 and diffused by the ink in the ink storage chamber 111, and hence, the light does not reach the light receiving part 125C. As such, the light receiving part 125C is configured to output a low-level signal (an example of a first signal) to the controller 130.

On the other hand, in a case where the level of ink stored in the ink storage chamber 111 is equal to or lower than the first detecting position P1, the ink no longer contacts the prism 125A and is separated from the prism 125A on the optical path. As such, the light emitted from the light emitting part 125B is reflected at the prism 125A and reaches the light receiving part 125C. At this time, the light receiving part 125C is configured to output a high-level signal (an example of a second signal) to the controller 130.

Incidentally, the light receiving part 125C may be configured to output a high-level signal when the level of ink is equal to or higher than the first detecting position P1, and output a low-level signal when the level of ink is lower than the first detecting position P1. The first sensor 125 is an example of “first sensor” of the disclosure.

### <Second Sensor 126>

The second sensor 126 is configured to detect whether the level of ink stored in the ink storage chamber 111 reaches a second detecting position P2. The second sensor 126 includes a prism 126A, a light emitting part 126B, and a light receiving part 126C (FIG. 4).

The prism 126A is provided on the rear wall 155 at a position lower than a center of the rear wall 155 in the up-down direction 7. In the present embodiment, the prism 126A is at a height equal to the height of the prism 125A in the up-down direction 7. The prism 126A constitutes a part of the rear wall 155. The prism 126A is made of glass that can provide a reflection coefficient that vary depending on whether ink is in contact with the prism 126A or not. As such, the second detecting position P2 is set at a position coincident with the position of the prism 126A in the up-down direction 7.

Here, preferably, a distance in the front-rear direction 8 between the first detecting position Pl and the second detecting position P2 be greater than one-half of the dimension in the front-rear direction 8 of the ink storage chamber 111. In the present embodiment, the distance in the front-rear direction 8 between the first detecting position P1 and the second detecting position P2 is substantially equal to a distance in the front-rear direction 8 between a rear surface of the front wall 151 and a front surface of the rear wall 155.

The light emitting part 126B and the light receiving part 126C are provided rearward of the prism 126A so as to face the prism 126A. The light emitting part 126B and the light receiving part 126C are supported by a rear surface of the rear wall 155. Incidentally, the light emitting part 126B and the light receiving part 126C may be supported by a wall surface defining the internal space of the tank receiving portion 101A. The light emitting part 126B is configured to emit light toward the prism 126A. The light emitting part 126B is electrically connected to the controller 130. The controller 130 is configured to control emission of the light from the light emitting part 126B.

The light receiving part 126C is configured to receive the light emitted from the light emitting part 126B and reflected at the prism 126A. The light receiving part 126C is electrically connected to the controller 130. The light receiving part 126C is configured to output signals indicative of intensity of the reflected light received at the light receiving part 126C. Specifically, in a case where the level of ink stored in the ink storage chamber 111 is higher than the second detecting position P2, the ink is in contact with the prism 126A on an optical path of the light emitted from the light emitting part 126B toward the prism 126A. At this time, the light emitted from the light emitting part 126B toward the prism 126A transmits through the prism 126A, enters in the ink storage chamber 111 and is diffused by the ink in the ink storage chamber 111, and hence, the light does not reach the light receiving part 126C. As such, the light receiving part 126C is configured to output a low-level signal (an example of a third signal) to the controller 130.

On the other hand, in a case where the level of ink stored in the ink storage chamber 111 is equal to or lower than the second detecting position P2, the ink does not contact the prism 126A and is separated from the prism 126A on the optical path pf the light emitted from the light emitting part 126B toward the prism 126A. At this time, the light emitted from the light emitting part 126B is reflected at the prism 126A and reaches the light receiving part 126C. As such, the light receiving part 126C is configured to output a high-level signal (an example of a fourth signal) to the controller 130.

Incidentally, the light receiving part 126C may be configured to output a high-level signal when the level of ink is equal to or higher than the second detecting position P2, and output a low-level signal when the level of ink is lower than the second detecting position P2. The second sensor 126 is an example of “second sensor” of the disclosure.

As illustrated in FIGS. 1A and 1B, the multi-color tank 19 is stationarily installed in a tank receiving portion 101B. The multi-color tank 19 is configured to store three kinds of ink, namely, cyan ink, magenta ink, and yellow ink (examples of “liquid” of the disclosure). The multi-color tank 19 is configured of three tanks corresponding to the three colors of the ink. Each tank has generally the same structure as the black tank 18 illustrated in FIG. 3. Hence, the structure of the multi-color tank 19 will not be described in detail here.

The tank receiving portion 101B has generally the same structure as the tank receiving portion 101A, except that: the tank receiving portion 101B is positioned on the right side of the opening 13 in the front end portion within the internal space of the main housing 14; the tank receiving portion 101B has an internal volume different from that of the tank receiving portion 101A; and the tank receiving portion 101B has three openings in the top wall 14C for the corresponding three inlet ports 143 of the multi-color tank 19.

### <Display 25>

The multifunction device 10 further includes a display 25 (see FIGS. 1A, 1B and 4). The display 25 is provided on a front wall of the movable housing 15. The display 25 is configured to display a message informing that the amount of ink stored in the ink storage chamber 111 is small (hereinafter, “ink low-level message”). The display 25 is configured to further display a message informing that the posture of the black tank 18 is tilted (hereinafter, “tilted posture message”), such as “the posture of the tank is tilted,” “the posture of the printer is tilted,” “please set the printer on a horizontal plane,” or “the posture of the printer is tilted, so please set the printer on a horizontal plane,” for example. The display 25 is electrically connected to the controller 130. The controller 130 is configured to control display on the display 25. Incidentally, the display 25 may be configured to further display a message about the multi-color tank 19 in the same manner as the black tank 18. The display 25 is an example of an “alarm unit” of the disclosure.

### <Controller 130>

The printer unit 11 further includes the controller 130 inside the main housing 14. As illustrated in FIG. 4, the controller 130 includes a CPU 131, a ROM 132, a RAM 133, an EEPROM 134, and an ASIC 135 all of which are electrically connected to one another through an internal bus 137.

The ROM 132 is configured to store programs with which the CPU 131 can control various operations. The RAM 133 is configured to be used as a storage area for temporarily storing data and signals that the CPU 131 uses to execute the programs or used as a working area for data processing. The EEPROM 134 is configured to store settings and flags to be held even after the multifunction device 10 is powered off.

For example, the EEPROM 134 is configured to store an initialization flag. The initialization flag represents values indicative of whether the multifunction device 10 performs its initial processing. Specifically, the initialization flag represents a first value indicating that the initial processing has not yet been performed, or a second value indicating that the initial processing has already been performed. The initial processing is a process for filling an ink flow path from the ink storage chamber 111 to the recording portion 21 with ink, i.e., filling the ink tube 32A with ink.

In factory default, the ink flow path from the ink storage chamber 111 to the recording portion 21 is not filled with ink in the multifunction device 10. That is, the first value is set in the initialization flag as a factory preset mode. When the controller 130 performs the initial processing, the ink tube 32A and the head 21A are filled with ink so that the multifunction device 10 is allowed to perform image recording on the image recording medium 5. That is, the second value is set in the initialization flag after the initial processing is performed. Incidentally, before shipment of the multifunction device 10, dedicated liquid for shipment (not used for image recording) may be filled in the ink flow path instead of ink. In this case, the shipment liquid may be discharged from the ink flow path upon execution of the initial processing by the controller 130, and ink may be filled in the ink flow path after the shipment liquid is discharged.

The conveyor 20, the recording portion 21, the display 25, the first sensor 125, and the second sensor 126 are electrically connected to the ASIC 135. The controller 130 is configured to control the conveyor 20 to convey the image recording medium 5 in the conveying direction. The controller 130 is configured to control the head 21A of the recording portion 21 to eject ink therefrom.

The controller 130 is configured to control the display 25 to display the ink low-level message thereon in response to receiving both the high-level signal from the first sensor 125 and the high-level signal from the second sensor 126. Further, the controller 130 is configured to control the display 25 to also display the ink low-level message thereon in response to a first time period having elapsed without receiving the high-level signal from the second sensor 126 after receiving the high-level signal from the first sensor 125. The first time period is, for example, 10 minutes.

Further, the controller 130 is configured to control the display 25 to display the tilted posture message in response to a second time period having elapsed without receiving the high-level signal from the first sensor 125 after receiving the high-level signal from the second sensor 126. The second time period is longer than the first time period. For example, the second time period is 20 minutes.

### <Image Recording Process>

An image recording process performed in the multifunction device 10 will next be described.

The controller 130 is configured to drive the conveyor 20 upon receipt of print data indicative of an image to be recorded on the image recording medium 5 from a data processing device that can communicate with the multifunction device 10. The conveyor 20 thus conveys the image recording medium 5 on the sheet supply tray 17, through the inlet 71, to the position below the head 21A. The controller 130 then controls the plurality of nozzles of the head 21A to eject ink therefrom toward the image recording medium 5, by which the image is recorded on the image recording medium 5.

As the ink stored in the ink storage chamber 111 is consumed through the ejection of the ink, air is introduced into the ink storage chamber 111 through the air communication port 111A. In this way, the level of the ink stored in the ink storage chamber 111 goes down in accordance with the consumption (ejection) of the ink in the ink storage chamber 111.

After the image is recorded on the image recording medium 5, the controller 130 further drives the conveyor 20 to discharge the image recording medium 5 onto the discharge tray 22. The controller 130 is configured to repeat the above-described image recording process until the print data to be recorded on the image recording medium 5 is no longer available.

### <Ink Residual Amount Detection Process>

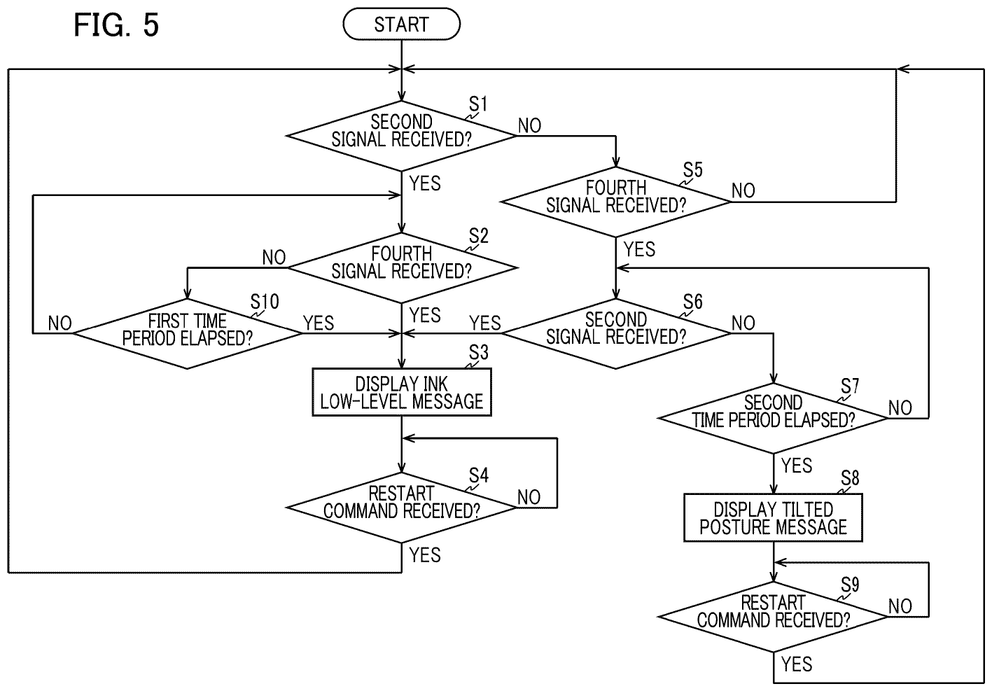

Next, description will be made as to how the controller 130 detects the amount of ink left in the ink storage chamber 111 during the image recording process with reference to flowchart in FIG. 5.

Here, as an initial state, the multifunction device 10 is assumed to store such an amount of ink in the ink storage chamber 111 that the level of the ink in the ink storage chamber 111 is positioned higher than both the first detecting position PI and the second detecting position P2 in a state where the multifunction device 10 is placed on a horizontal plane.

First, the controller 130 determines whether the high-level signal (second signal) has been received from the first sensor 125 (S1). When the high-level signal is determined to have been received from the first sensor 125 (S1: YES), the routine process to S2. On the other hand, when the controller 130 determines in SI that the high-level signal has not been received from the first sensor 125 (S1: NO), the routine proceeds to S5.

In S2, the controller 130 determines whether the high-level signal (fourth signal) has been received from the second sensor 126. When the controller 130 determines that the high-level signal has been received from the second sensor 126 (S2: YES), the routine proceeds to S3. On the other hand, when the controller 130 determines that the high-level signal has not been received from the second sensor 126 (S2: NO), the routine proceeds to S10.

In S3, the controller 130 stops driving the conveyor 20 and controls the display 25 to display the ink low-level message thereon. As such, the user can be informed of the fact that the residual amount of ink in the ink storage chamber 111 is small, so that the user can replenish the black tank 18 with fresh black ink before the ink in the ink storage chamber 111 is used up. For replenishment of ink, the user detaches the cap 104, and inserts a nozzle of an ink bottle (as an example of a “liquid container” of the disclosure) into the inlet port 143 of the ink storage chamber 111.

Thereafter, the controller 130 waits for a restart command to be inputted by the user (S4: NO). Upon receipt of the restart command (S4: YES), the controller 130 starts driving the conveyor 20 and the routine returns to S1.

In S5, the controller 130 determines whether the high-level signal has been received from the second sensor 126. When the high-level signal is determined not to have been received (S5: NO), the routine returns to S1. When the high-level signal from the second sensor 126 is determined to have been received (S5: YES), the routine proceeds to S6.

In S6, the controller 130 determines whether the high-level signal from the first sensor 125 has been received. When the high-level signal from the first sensor 125 has been received (S6: YES), the routine proceeds to S3. When the high-level signal from the first sensor 125 has not been received (S6: NO), the routine proceeds to S7.

In S7, the controller 130 determines whether the second time period has elapsed after receiving the high-level signal from the second sensor 126. When the controller 130 determines that the second time period has not yet elapsed (S7: NO), the routine returns to S6.

When the controller 130 determines in S7 that the second time period has elapsed (S7: YES), the routine proceeds to S8.

In S8, the controller 130 stops driving the conveyor 20 and controls the display 25 to display the tilted posture message thereon. Accordingly, the user can be informed of the fact that the black tank 18 is tilted relative to a horizontal plane. The user can therefore set the multifunction device 10 on a horizontal plane again to correct the tilted posture of the black tank 18.

The controller 130 then waits for the restart command to be inputted by the user (S9: NO). Upon receipt of the restart command (S9: YES), the controller 130 starts driving the conveyor 20 and the routine returns to S1.

In S10, the controller 130 determines whether the first time period has elapsed after receiving the high-level signal (fourth signal) from the second sensor 126. When the controller 130 determines that the first time period has not elapsed (S10: NO), the routine returns to S2. On the other hand, when the controller 130 determines that the first time period has elapsed (S10: YES), the routine proceeds to S3. The above-described ink residual amount detection process is configured to be repeated until the print data to be recorded on the image recording medium 5 is no longer available.

### <Technical Advantages of the Embodiment>

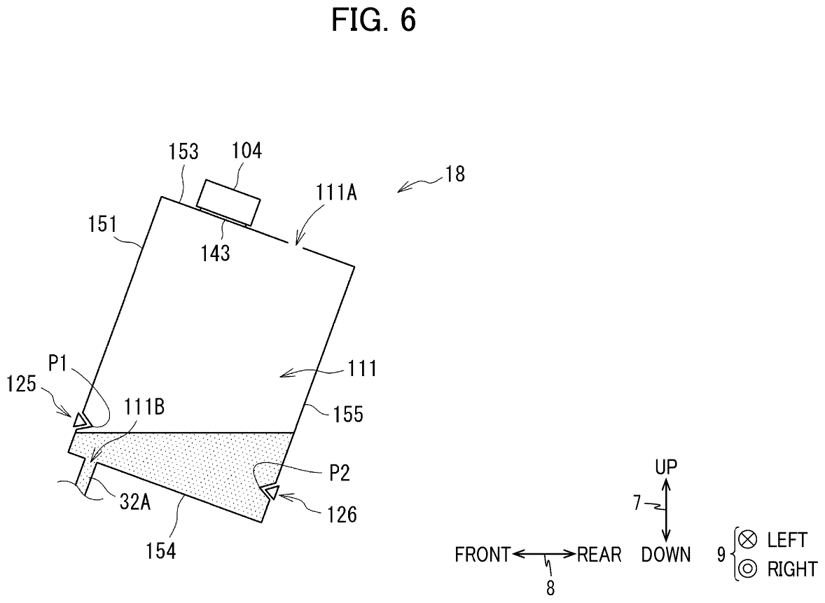

In the multifunction device 10, the first sensor 125 and the second sensor 126 are arranged to be spaced away from each other in the front-rear direction 8. With this configuration, in a case where the multifunction device 10 is set on an inclined surface inclined relative to the front-rear direction 8 such that the rear end portion of the multifunction device 10 is positioned lower than the front end portion thereof, the bottom surface of the ink storage chamber 111 is also inclined relative to the horizontal plane as illustrated in FIG. 6. Even in this inclined state, the level of the ink in the ink storage chamber 111 is likely to be higher than the second detecting position P2, while being lower than the first detecting position P1. Accordingly, the second sensor 126 outputs the low-level signal indicating that the ink is detected at the second detecting position P2. That is, the controller 130 is less likely to detect that the residual amount of the ink in the ink storage chamber 111 is low, notwithstanding the fact that the level of the ink stored in the ink storage chamber 111 is still above the first detecting position Pl and the second detecting position P2 if the multifunction device 10 was set on a horizontal plane. Consequently, detection of the residual amount of ink in the ink storage chamber 111 by the first sensor 125 and the second sensor 126 can be performed with little reduction in accuracy even if the multifunction device 10 is set on an inclined surface.

Further, in the multifunction device 10, the ink storage chamber 111 has a rectangular parallelepiped shape elongated in the front-rear direction 8 with the front-rear dimension greater than the left-right dimension. With this configuration, in a state the bottom surface of the ink storage chamber 111 is inclined relative to the front-rear direction 8, the liquid surface of the ink stored in the ink storage chamber 111 is positioned significantly deviated from the first sensor 125 disposed at the front wall 151 and from the second sensor 126 disposed at the rear wall 155 with respect to the up-down direction 7. Hence, detection of the residual amount of ink in the ink storage chamber 111 by the first sensor 125 and the second sensor 126 can be performed with little reduction in accuracy.

Further, in the multifunction device 10, the first detecting position PI and the second detecting position P2 are at the same position (height) as each other in the up-down direction 7. This configuration can further effectively restrain reduction in accuracy of detecting the residual amount of ink by the first and second sensors 125, 126.

Further, in the multifunction device 10, the controller 130 controls the display 25 to display the ink low-level message thereon (S3 in FIG. 5) in response to receiving the high-level signal from one of the first sensor 125 and the second sensor 126 (S2: YES in FIG. 5) after receiving the high-level signal from a remaining one of the first sensor 125 and the second sensor 126 (S1: YES in FIG. 5).

With this configuration, in a case where a sufficient amount of ink is left in the ink storage chamber 111 (in a case where the level of the ink stored in the ink storage chamber 111 is higher than both the first detecting position PI and the second detecting position P2 in a state where the multifunction device 10 was set on a horizontal plane), the controller 130 can control the display not to display the ink low-level message thereon even if the liquid surface of the ink in the ink storage chamber 111 becomes inclined relative to the bottom surface of the ink storage chamber 111. Accordingly, detection accuracy in detecting the residual amount of ink by the first and second sensors 125, 126 can be restrained from getting deteriorated.

Further, in the multifunction device 10, the outlet port 111B is positioned in the front end portion of the lower wall 154. That is, the outlet port 111B is positioned closer to the first detecting position PI than to the second detecting position P2 with respect to the front-rear direction 8. Hence, in a case where the multifunction device 10 is set on an inclined surface that is sloped relative to the front-rear direction 8 such that the rear end of the multifunction device 10 is positioned lower than the front end thereof to provide the posture of the black tank 18 as illustrated in FIG. 6, the outlet port 111B is likely to be exposed to the air in the ink storage chamber 111 (i.e., the outlet port 111B may not be covered by the ink stored in the ink storage chamber 111), since the level of the ink in the ink storage chamber 111 would become lower by the time when the controller 130 receives the high-level signal from the second sensor 126 after receiving the high-level signal from the first sensor 125. If the outlet port 111B is not covered with ink, air may flow into the head 21A through the outlet port 111B.

To this effect, in the multifunction device 10 according to the present embodiment, the controller 130 controls the display 25 to display the ink low-level message thereon when the first time period has elapsed without receiving the high-level signal from the second sensor 126 after receiving the high-level signal from the first sensor 125 (S1: YES, S2: NO, S10: YES in FIG. 5). Hence, this configuration of the embodiment not only restrains reduction in detection accuracy of the residual amount of ink by the first and second sensors 125, 126, but also prompts the user to replenish the black tank 18 with fresh black ink by connecting a new ink bottle thereto (S3 in FIG. 5) such that the outlet port 111B can be restrained from being uncovered with the black ink.

Further, in the multifunction device 10, the black tank 18 is assumed to be inclined relative to a horizontal plane such that the bottom surface of the ink storage chamber 111 is inclined significantly relative to the horizontal plane in a case where the controller 130 has not received the high-level signal from one of the first sensor 125 and the second sensor 126 for the second time period longer than the first time period after receiving the high-level signal from a remaining one of the first sensor 125 and the second sensor 126 (S1: NO, S5: YES, S6: NO, S17: YES in FIG. 5). In this state where the bottom surface of the ink storage chamber 111 is largely inclined with respect to the horizontal plane, the outlet port 111B may be exposed out of the ink in the ink storage chamber 111 when the level of the ink in the ink storage chamber 111 is lowered.

To this effect, in the multifunction device 10 according to the present embodiment, the controller 130 controls the display 25 to display the tilted posture message indicating that the black tank 18 is tilted (S8 in FIG. 5) when the second time period has elapsed without receiving the high-level signal from the first sensor 125 after receiving the high-level signal from the second sensor 126 (S1: NO, S5: YES, S6: NO, S7: YES in FIG. 5). Accordingly, the user can recognize, through the tilted posture message on the display 25, that the black tank 18 is largely inclined, so that the user can re-arrange the multifunction device 10 on the horizontal plane to correct the posture of the black tank 18.

### <Modifications>

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

In the multifunction device 10 according to the above-described embodiment, the first detecting position P1 and the second detecting position P2 are spaced apart from each other in the front-rear direction 8. However, the first and second detecting positions P1 and P2 need not be spaced apart from each other in the front-rear direction 8, provided that the first detecting position P1 and the second detecting position P2 are spaced apart from each other horizontally. For example, the first and second detecting positions P1 and P2 may be spaced apart from each other in the left-right direction 9.

In the multifunction device 10 according to the above-described embodiment, an ink bottle (as the liquid container) is connectable to the black tank 18 for replenishment thereof with black ink. However, the liquid container may be in a form of an ink cartridge, rather than an ink bottle. If the ink cartridge is employed as the liquid container, an inlet port of the black tank 18 may be arranged below both the first detecting position P1 and the second detecting position P2 in order to receive black ink from the ink cartridge through the inlet port.

In the multifunction device 10 according to the above-described embodiment, the outlet port 111B is positioned in the lower wall 154. However, the outlet port 111B may be positioned in one of the walls other than the lower wall 154 defining the ink storage chamber 111, provided that the outlet port 111B is positioned below both the first detecting position P1 and the second detecting position P2. For example, the outlet port 111B may be positioned in a lower end portion of the front wall 151 or in a lower end portion of the rear wall 155.

In the multifunction device 10 according to the above-described embodiment, the ink storage chamber is a rectangular parallelepiped internal space whose dimension in the front-rear direction 8 is greater than its dimension in the left-right direction 9. However, the shape of the ink storage chamber 111 may be arbitrary, as long as the ink storage chamber 111 can store ink therein.

In the multifunction device 10 according to the above-described embodiment, the first detecting position PI and the second detecting position P2 are at the same position as each other in the up-down direction 7. However, the first detecting position PI and the second detecting position P2 may be positioned slightly offset from each other with respect to the up-down direction 7.

In the multifunction device 10 according to the above-described embodiment, the controller 130 is configured to control the display 25 to display messages thereon for notification to the user. However, the notification to the user may be performed through other methods other than through displaying messages. For example, an alarm may be used, instead of the display 25, to inform the user through sounds of some kind.

In the multifunction device 10 according to the above-described embodiment, the first sensor 125 and the second sensor 126 are prism type photosensors configured of the prisms 125A, 126A, the light emitting parts 125B, 126B, and the light receiving parts 125C, 126C. However, sensors other than the prism type photosensor may be used as the sensor of the disclosure, as long as a light receiving part of the sensor can output different electrical signals depending on whether the light receiving part receives light emitted from a light emitting part of the same sensor. For example, the first sensor 125 and the second sensor 126 may be a thru-beam type photosensor, a reflective type photosensor, a separation type photosensor, and an actuator type photosensor. Still alternatively, the first sensor 125 and the first sensor 125 may be a liquid level sensor using three electrodes. In this case, the three electrodes may be arranged at intervals in the front-rear direction 8 inside the ink storage chamber 111. The three electrodes may be incorporated in an electrical circuit such that different electrical signals can be outputted in response to detecting that the two of the three electrodes contact the ink in the ink storage chamber 111.

In the multifunction device 10 according to the above-described embodiment, the outlet port 111B is positioned in the front end portion of the lower wall 154. However, the outlet port 111B may be provided at a position different from that in the embodiment.

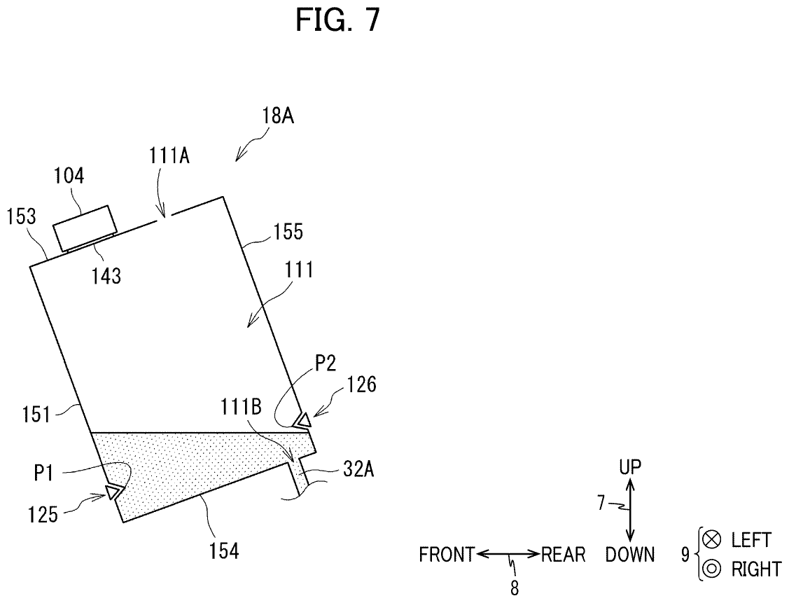

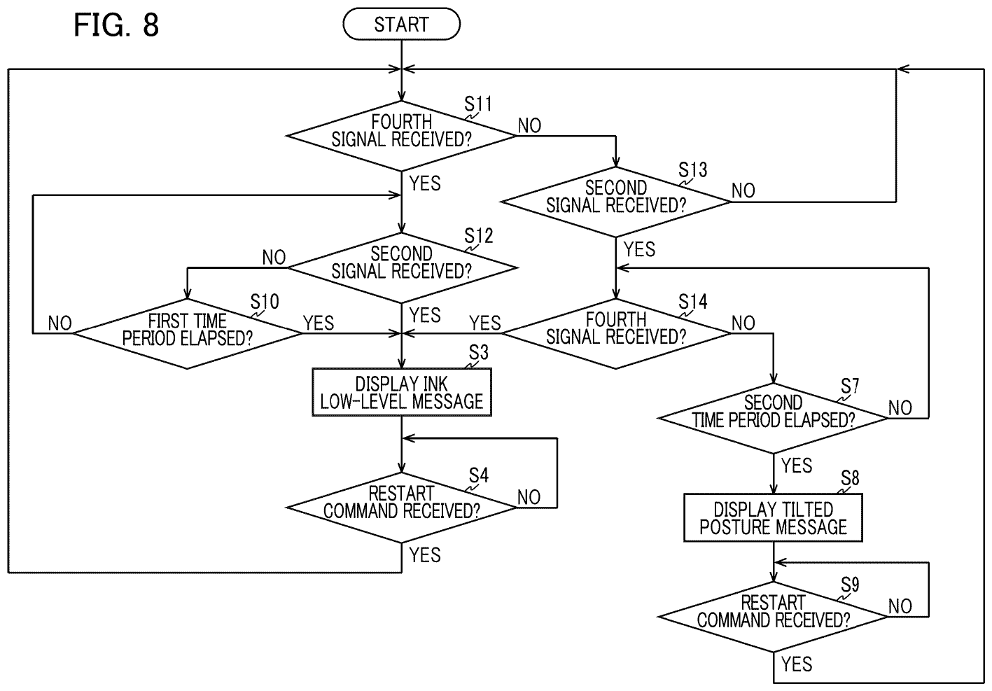

As an example, FIG. 7 illustrates a black tank 18A according to a modification to the embodiment in which the outlet port 111B is provided in a rear end portion of the lower wall 154. FIG. 8 illustrates steps to be performed in the ink residual amount detection process according to this modification. The ink residual amount detection process according to this modification (illustrated in FIG. 8) is the same as the ink residual amount detection process according to the embodiment (illustrated in FIG. 5) except in steps S11, S12, S13 and S14 which are to be executed instead of the steps S1, S2, S5 and S6 in FIG. 5, respectively. In short, in these steps 11, 12, 13 and 14 in FIG. 8 according to this modification, the controller 130 is configured to receive signals opposite the signals that the controller 130 receives in the steps S1, S2, S5 and S6 in FIG. 5 according to the embodiment.

As such, hereinafter, with respect to the flowchart of FIG. 8, the steps the same as those in FIG. 5 will be designated by the same step numbers to avoid duplicating description. Incidentally, the first time period in FIG. 8 may be different from the first time period in FIG. 5. Further, the second time period in FIG. 8 may be different from the second time period in FIG. 5.

In the black tank 18A illustrated in FIG. 7, since the outlet port 111B is positioned in the rear end portion of the lower wall 154, the outlet port 111B is positioned closer to the second detecting position P2 than to the first detecting position PI in the front-rear direction 8. Hence, in a case where the multifunction device 10 including the black tank 18A is set on an inclined surface sloping relative to the front-rear direction 8 such that the front end of the lower wall 154 is positioned lower than the rear end of the lower wall 154 as illustrated in FIG. 7, the outlet port 111B is likely to be exposed to the air in the ink storage chamber 111, because the level of the ink in the ink storage chamber 111 goes down by the time when the controller 130 receives the high-level signal from the first sensor 125 after receiving the high-level signal from the second sensor 126. In a state where the outlet port 111B is not covered with ink, air may flow into the head 21A through the outlet port 111B.

To this effect, in the multifunction device 10 including the black tank 18A, the controller 130 controls the display 25 to display the ink low-level message when the first time period has elapsed without receiving the high-level signal from the first sensor 125 after receiving the high-level signal from the second sensor 126. With this configuration, deterioration in detection accuracy on the residual amount of the ink by the first and second sensors 125, 126 can be restrained, and further, the ink low-level message can prompt the user to connect a new ink bottle to the black tank 18A to replenish the black tank 18A with fresh black ink, so that the outlet port 111B is less likely to be exposed out of the ink left in the ink storage chamber 111.

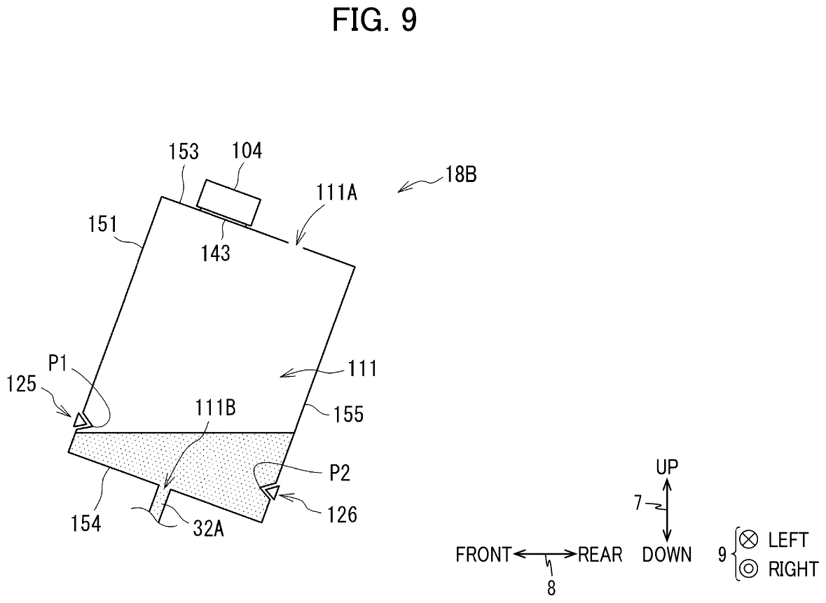

As another alternative example, FIG. 9 depicts a black tank 18B according to another modification to the embodiment. In this black tank 18B, the outlet port 111B is provided at a center of the lower wall 154 in the front-rear direction 8. Accordingly, in a case where the multifunction device 10 including the black tank 18B is set on an inclined surface sloping relative to the front-rear direction 8 such that the front end and the rear end of the lower wall 154 are positioned at different heights from each other in the up-down direction 7 as illustrated in FIG. 9, the outlet port 111B is less likely to be exposed to the air in the ink storage chamber 111 even if the level of the ink is lowered, compared to those structures where the outlet port 111B is positioned deviated frontward or rearward from the center of the lower wall 154 in the front-rear direction 8.

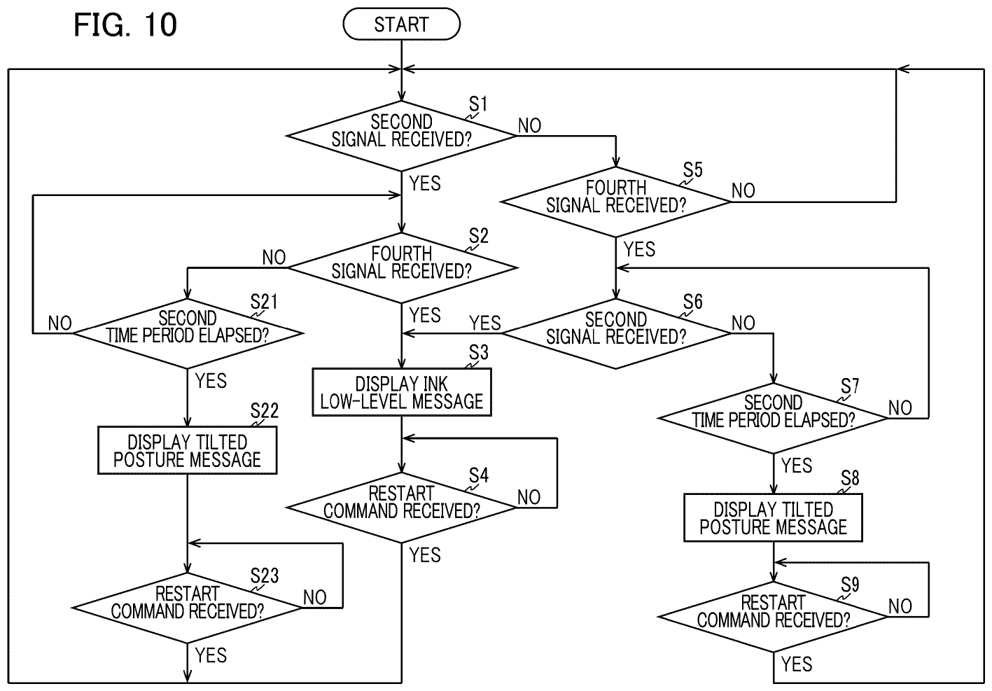

FIG. 10 illustrates steps to be performed in the ink residual amount detection process according to this alternative modification. The ink residual amount detection process according to this modification (illustrated in FIG. 10) is the same as the ink residual amount detection process according to the embodiment (illustrated in FIG. 5) except in steps S21, S22 and S23 which are to be executed instead of the step S10 in FIG. 5. Here, the steps S21, S22 and S23 to be executed in FIG. 10 are the same as the steps S7, S8 and S9 to be executed in FIG. 5 according to the embodiment.

As such, hereinafter, with respect to the flowchart of FIG. 10, the steps the same as those in FIG. 5 will be designated by the same step numbers to avoid duplicating description. Only the steps S21, S22 and S23, which are to be executed instead of the step S10 in FIG. 5 according to embodiment, will be described with respect to the flowchart of FIG. 10, since other steps in FIG. 10 are the same as those in the flowchart of FIG. 5.

Referring to FIG. 10, the controller 130 determines in S21 whether the second time period has elapsed after receiving the high-level signal from the first sensor 125 (S1: YES, S2: NO). When the controller 130 determines in S21 that the second time period has not elapsed (S21: NO), the routine returns to S2. In contrast, when the controller 130 determines in S21 that the second time period has elapsed (S21: YES), the routine proceeds to S22. In S22, the controller 130 stops driving the conveyor 20, and controls the display 25 to display the tilted posture message indicating that posture of the black tank 18B is tilted. Accordingly, the user can be notified, through the message on the display 25, that the black tank 18B is inclined, so that the user can re-arrange the multifunction device on a horizontal plane to correct the posture of the black tank 18B. Next, in S23, the controller 130 waits for the restart command to be inputted by the user (S23: NO). Upon receipt of the restart command (S23: YES), the controller 130 starts driving the conveyor 20 and goes back to S1.

What is claimed is:

1. A tank to which a liquid container storing liquid therein is connectable, the tank comprising:
a liquid storage chamber configured to store the liquid supplied from the liquid container connected to the tank, the liquid storage chamber defining a first detecting position and a second detecting position therein, the first detecting position and the second detecting position being spaced apart from each other in a horizontal direction, the liquid storage chamber having:
a liquid inlet port through which the liquid in the liquid container is to be supplied, the liquid inlet port being positioned above the first detecting position and the second detecting position in an up-down direction; and
a liquid outlet port through which the liquid in the liquid storage chamber is to be discharged, the liquid outlet port being positioned lower than the first detecting position and the second detecting position in the up-down direction;
a first sensor configured to detect the liquid at the first detecting position, the first sensor being configured to output a first signal in response to detecting the liquid at the first detecting position and output a second signal in response to not detecting the liquid at the first detecting position; and
a second sensor configured to detect the liquid at the second detecting position, the second sensor being configured to output a third signal in response to detecting the liquid at the second detecting position and output a fourth signal in response to not detecting the liquid at the second detecting position.

2. The tank according to claim 1,
wherein the liquid storage chamber has a rectangular parallelepiped shape elongated in the horizontal direction, the liquid storage chamber having one end and another end in the horizontal direction, and
wherein the first sensor is positioned closer to the one end than to the another end in the horizontal direction, and the second sensor is positioned closer to the another end than to the one end in the horizontal direction.

3. The tank according to claim 1,
wherein the first detecting position and the second detecting position are at the same position as each other in the up-down direction.

4. An image recording apparatus comprising:
the tank according to claim 1;
an ejection head configured to eject the liquid supplied from the tank through the liquid outlet port;
an alarm unit configured to perform a low-level notification to notify that an amount of the liquid stored in the liquid storage chamber is small; and
a controller electrically connected to the first sensor, the second sensor and the alarm unit, the controller being configured to control the alarm unit to perform the low-level notification in response to receiving both the second signal and the fourth signal.

5. The image recording apparatus according to claim 4,
wherein the liquid outlet port is positioned closer to the second detecting position than to the first detecting position in the horizontal direction, and
wherein the controller is configured to control the alarm unit to perform the low-level notification in response to a first time period having elapsed without receiving the second signal after receiving the fourth signal.

6. The image recording apparatus according to claim 5,
wherein the alarm unit is further configured to perform a tilted posture notification to notify that a posture of the tank is tilted relative to the horizontal direction, and
wherein the controller is further configured to control the alarm unit to perform the tilted posture notification in response to a second time period having elapsed without receiving the fourth signal after receiving the second signal, the second time period being longer than the first time period.

7. The image recording apparatus according to claim 4,
wherein the liquid outlet port is positioned closer to the first detecting position than to the second detecting position in the horizontal direction, and
wherein the controller is configured to control the alarm unit to perform the low-level notification in response to a first time period having elapsed without receiving the fourth signal after receiving the second signal.

8. The image recording apparatus according to claim 7,
wherein the alarm unit is further configured to perform a tilted posture notification to notify that a posture of the tank is tilted relative to the horizontal direction, and
wherein the controller is further configured to control the alarm unit to perform the tilted posture notification in response to a second time period having elapsed without receiving the second signal after receiving the fourth signal, the second time period being longer than the first time period.

9. The image recording apparatus according to claim 4,
wherein the liquid outlet port is positioned at a center between the first detecting position and the second detecting position in the horizontal direction.

10. The image recording apparatus according to claim 9,
wherein the alarm unit is further configured to perform a tilted posture notification to notify that a posture of the tank is tilted relative to the horizontal direction, and
wherein the controller is further configured to control the alarm unit to perform the tilted posture notification in response to a second time period having elapsed without receiving one of the second signal and the fourth signal after receiving a remaining one of the second signal and the fourth signal, the second time period being longer than the first time period.
